(19) United States
(12) Patent Application Publication
(10) Pub. No.: US 2026/0274196 A1
(43) Pub. Date: Sep. 17, 2026

(54) SEAT BELT DEVICE

(71) Applicant: SUBARU CORPORATION, Tokyo (JP)

(72) Inventor: Koichi MASHIKO, Tokyo (JP)

(21) Appl. No.: 19/545,137

(22) Filed: Feb. 20, 2026

(30) Foreign Application Priority Data
Mar. 17, 2025 (JP) 2025-042983

(51) Int. Cl. B60R 22/14

(52) U.S. Cl. CPC B60R 22/14

(57) ABSTRACT

A seat belt device includes a seat belt, a tongue, a buckle, and an adapter. The tongue is attached to the seat belt such that the tongue is slidable in a longitudinal direction. The tongue is configured to be attached to and detached from the buckle. The adapter is attached to the tongue and is made of a flexible material having a larger friction coefficient than a material of the seat belt. The adapter is disposed to extend from the tongue along an inner surface of the seat belt. The adapter is configured such that, in a state in which the tongue is attached to the buckle, the adapter is disposed between the seat belt and an ilium of an occupant.

### CROSS-REFERENCE TO RELATED APPLICATIONS

The present application claims priority from Japanese Patent Application No. 2025-042983 filed on Mar. 17, 2025, the entire contents of which are hereby incorporated by reference.

### BACKGROUND

The disclosure relates to a seat belt device.

Hitherto, a vehicle is provided with a protection device that protects an occupant when the vehicle collides with an object. For example, Japanese Unexamined Patent Application Publication (JP-A) No. 2007-210420 discloses a seat belt device that restrains the body of an occupant on a seat to prevent the occupant from colliding with an object outside the seat when the vehicle collides with the object.

The seat belt device described in JP-A No. 2007-210420 includes a seat belt including a shoulder belt portion that comes into contact with the chest of the occupant to restrain the chest of the occupant, and a lap belt portion that comes into contact with the waist of the occupant to restrain the waist of the occupant. The shoulder belt portion described in JP-A No. 2007-210420 includes a bag-shaped belt portion that is inflated by gas from an inflator in the event of a collision of the vehicle. Therefore, in the event of a collision of the vehicle, the pressure that is applied to the chest of the occupant can be dispersed.

### SUMMARY

An aspect of the disclosure provides a seat belt device including a seat belt, a tongue, a buckle, and an adapter. The tongue is attached to the seat belt such that the tongue is slidable in a longitudinal direction. The tongue is configured to be attached to and detached from the buckle. The adapter is attached to the tongue and is made of a flexible material having a larger friction coefficient than a material of the seat belt. The adapter is disposed to extend from the tongue along an inner surface of the seat belt. The adapter is configured such that, in a state in which the tongue is attached to the buckle, the adapter is disposed between the seat belt and an ilium of an occupant.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a schematic diagram illustrating a configuration of a vehicle according to an embodiment of the disclosure;

FIG. 2 is a block diagram illustrating an example of a configuration of a control device according to the embodiment;

FIG. 3 is a block diagram illustrating an example of a functional configuration of the control device according to the embodiment;

FIG. 4 is a sectional view of an adapter according to the embodiment as viewed in a width direction;

FIG. 5 is a sectional view of the adapter according to the embodiment as viewed in a longitudinal direction;

FIG. 6 is a schematic diagram illustrating a seat belt wearing state of the seat belt device according to the embodiment at the time of non-collision;

FIG. 7 is a schematic diagram illustrating a positional relationship between the adapter according to the embodiment and the waist of an occupant;

FIG. 8 is a schematic diagram illustrating an engagement state between the adapter according to the embodiment and the ilium of the occupant; and

FIG. 9 is a schematic diagram illustrating an engagement state between the adapter and a lap belt portion according to the embodiment.

### DETAILED DESCRIPTION

In the event of a collision of a vehicle, an inertial force acts on an occupant sitting on a seat to move the occupant in a forward movement direction of the vehicle. At this time, the pressure applied to the chest of the occupant from a seat belt increases as the position of the ilium of the occupant wearing the seat belt is farther from the turning point of the seat belt at the tongue. This is because, as the position of the ilium of the occupant is farther from the turning point, part of the seat belt is more likely to ride on the ilium of the occupant when the occupant leans forward due to the inertial force. The distance from the chest of the occupant to the turning point through the ilium is longer than the shortest distance from the chest of the occupant to the turning point. Therefore, when part of the seat belt rides on the ilium of the occupant, the chest of the occupant is tightened by the seat belt as compared with the case where the part of the seat belt does not ride on the ilium. As a result, the pressure applied to the chest of the occupant from the seat belt increases.

It is desirable to reduce the pressure applied to the chest of the occupant from the seat belt in the event of a collision.

Hereinafter, an embodiment of the disclosure will be described in detail with reference to the accompanying drawings. Specific dimensions, materials, numerical values, and the like described in the embodiment are examples for facilitating understanding of the embodiment of the disclosure, and do not limit the embodiment of the disclosure unless otherwise specified. The relative sizes of constituent members illustrated in the drawings do not necessarily accurately indicate the actual size relationship between the constituent members. In this specification and the drawings, elements having substantially the same functions and configurations are denoted by the same reference numerals to omit redundant description, and elements not directly related to the embodiment of the disclosure are not illustrated.

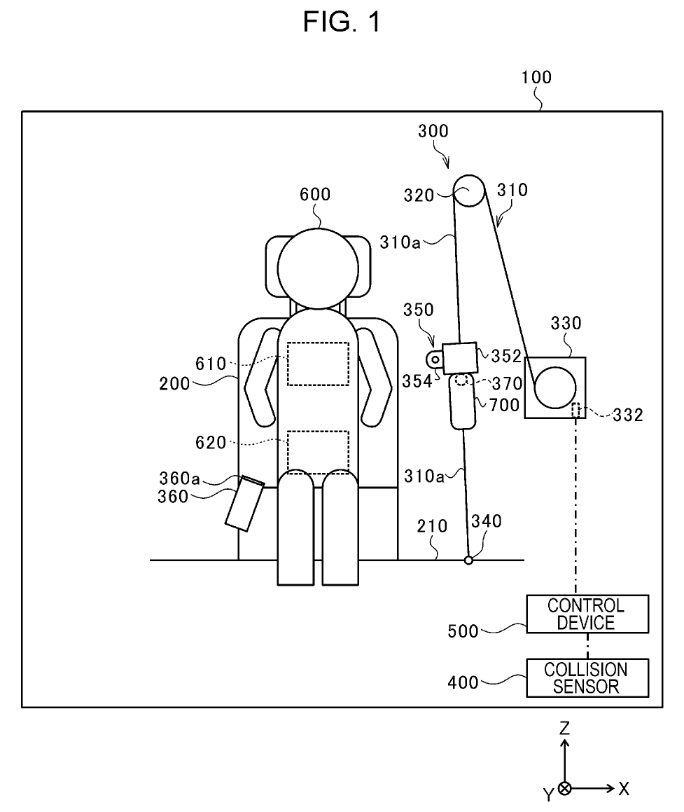

FIG. 1 is a schematic diagram illustrating a configuration of a vehicle 100 according to the present embodiment. In FIG. 1, a Z direction indicates a vertical direction. A +Z direction indicates an upward direction in the vertical direction, and a -Z direction indicates a downward direction in the vertical direction. In FIG. 1, an X direction indicates a predetermined direction in a horizontal direction, and a Y direction indicates a direction orthogonal to the X direction in the horizontal direction. The X direction is, for example, a right-left direction of the vehicle 100, a -X direction is a rightward direction of the vehicle 100, and a +X direction is a leftward direction of the vehicle 100. The Y direction is, for example, a front-rear direction of the vehicle 100, a -Y direction is a forward direction of the vehicle 100, and a +Y direction is a rearward direction of the vehicle 100. The -Y direction that is the forward direction of the vehicle 100 is a forward movement direction of the vehicle 100. The +Y direction that is the rearward direction of the vehicle 100 is a backward movement direction of the vehicle 100.

The vehicle 100 is, for example, a hybrid vehicle including two drive sources that are an engine and a drive motor. However, the drive source of the vehicle 100 may be only an engine or only a drive motor, and various vehicle types such as an engine vehicle and an electric vehicle can be adopted. A configuration related to features of the present embodiment will be described in detail, and description of a configuration unrelated to the features of the present embodiment will be omitted.

As illustrated in FIG. 1, the vehicle 100 includes a seat 200, a seat belt device 300, a collision sensor 400, and a control device 500. FIG. 1 illustrates a non-seat belt wearing state of the seat belt device 300 in which a tongue 350 described in detail later is not attached to a buckle 360.

The seat 200 is provided in a cabin of the vehicle 100, and is a seat for an occupant 600 to sit on. In the present embodiment, the seat 200 is, for example, a front passenger seat. However, the seat 200 is not limited thereto, and may be a driver's seat or a rear seat. The seat 200 is provided on a vehicle body panel 210. The vehicle body panel 210 is, for example, a floor panel.

The seat belt device 300 is an example of a protection device that protects the occupant 600 when the vehicle 100 collides with an object. The seat belt device 300 restrains the body of the occupant 600 on the seat 200 to prevent the occupant 600 from colliding with an object outside the seat 200 when the vehicle 100 collides with the object. The seat belt device 300 is provided in the cabin of the vehicle 100.

The seat belt device 300 includes a seat belt 310, a shoulder anchor 320, a shoulder retractor 330, a lap anchor 340, the tongue 350, the buckle 360, and a tongue stopper 370.

The seat belt 310 is a restraining member that restrains the occupant 600 sitting on the seat 200. The seat belt 310 is a band-shaped belt made of polyester fibers or the like. One end of the seat belt 310 is coupled to the shoulder retractor 330, and the other end of the seat belt 310 is coupled to the lap anchor 340. Hereinafter, the longitudinal direction of the seat belt 310 may be referred to as an extending direction of the seat belt 310.

The shoulder anchor 320 is a support member that supports the seat belt 310. The shoulder anchor 320 supports the seat belt 310 between the one end of the seat belt 310 and the tongue 350. The shoulder anchor 320 is provided, for example, at an upper portion of a pillar of the vehicle 100, and is disposed above the seat 200.

The shoulder retractor 330 is coupled to the one end of the seat belt 310 and has a winding function of winding the one end side of the seat belt 310. Further, the shoulder retractor 330 has a function of paying out the one end of the seat belt 310. The shoulder retractor 330 is provided on the pillar of the vehicle 100 and is disposed below the shoulder anchor 320.

Specifically, the shoulder retractor 330 includes a spool to which the one end of the seat belt 310 is locked. The spool is provided with a winding spring that constantly urges a rotary shaft of the spool in a winding direction.

Thus, the shoulder retractor 330 can wind the seat belt 310 in the winding direction by the urging force of the winding spring. The shoulder retractor 330 can pay out the seat belt 310 when a pulling force greater than the urging force of the winding spring is applied to the seat belt 310.

The shoulder retractor 330 has a pretensioner function. The pretensioner function is, for example, a function of winding the seat belt 310 to eliminate slack of the seat belt 310 when the vehicle 100 receives an impact due to a collision between an object and the vehicle 100. In other words, the shoulder retractor 330 has a function of winding the seat belt 310 when a collision of the vehicle 100 is detected by the collision sensor 400.

Specifically, an inflator 332 is provided inside the shoulder retractor 330. The inflator 332 is a gas generator that ignites an explosive and generates gas by a chemical reaction due to combustion. The gas generated by the inflator 332 presses, for example, a ball disposed in a cylinder, and ejects the ball from the cylinder at a high speed. The ball ejected from the cylinder at a high speed collides with the spool. The spool can be rotated in the winding direction by collision energy between the ball and the spool. As a result, the seat belt 310 can be instantaneously wound in the event of a collision of the vehicle 100.

The lap anchor 340 is coupled to the other end of the seat belt 310 and fixes the other end of the seat belt 310 to the vehicle body panel 210. That is, the lap anchor 340 is a fixing member that fixes the other end of the seat belt 310 to the vehicle body panel 210. The lap anchor 340 is provided, for example, on the floor panel of the vehicle body, and is disposed below the shoulder retractor 330.

The tongue 350 is a member that engages with the buckle 360 to allow the occupant 600 to wear the seat belt 310. The tongue 350 includes a body 352 and a tongue plate 354. The body 352 is coupled to the tongue plate 354 and supports the tongue plate 354. The tongue plate 354 is an engaging member that engages with the buckle 360.

An insertion hole (not illustrated) is formed in the body 352 of the tongue 350 such that the seat belt 310 can be inserted therethrough. Since the width of the insertion hole is larger than the width of the seat belt 310, the tongue 350 is movable along the longitudinal direction of the seat belt 310. The body 352 is slidably supported by the seat belt 310 in a state in which the seat belt 310 is inserted through the insertion hole.

The buckle 360 is an engaged member that is attachable to and detachable from the tongue plate 354 and is engaged with the tongue plate 354. The buckle 360 is fixed to the seat 200. However, the buckle 360 is not limited thereto, and may be fixed to the vehicle body panel 210. An insertion slot 360a is formed in the buckle 360. The buckle 360 is provided with a latch mechanism (not illustrated) and an unlatching button (not illustrated).

When the tongue plate 354 is inserted into the insertion slot 360a, the tongue plate 354 and the latch mechanism engage with each other. When the unlatching button is pressed by the occupant 600 in the engagement state in which the tongue plate 354 and the latch mechanism engage with each other, the tongue plate 354 and the latch mechanism disengage from each other.

The tongue stopper 370 is a regulating member that regulates the movement of the tongue 350. The tongue stopper 370 is provided on the seat belt 310. The tongue stopper 370 is provided closer to the lap anchor 340 than the tongue 350 on the seat belt 310. The tongue stopper 370 can regulate the movement of the tongue 350 toward the lap anchor 340 by coming into contact with the body 352 of the tongue 350.

In the state illustrated in FIG. 1, the tongue stopper 370 regulates the movement of the tongue 350 such that the tongue 350 does not move downward beyond the vicinity of the shoulder of the occupant 600. Thus, when the occupant 600 wears the seat belt 310, the occupant 600 can easily grasp the tongue 350 disposed in the vicinity of the shoulder of the occupant 600.

The collision sensor 400 detects a collision between the vehicle 100 and an object and transmits a signal indicating the collision between the vehicle 100 and the object to the control device 500. The collision sensor 400 is, for example, a pressure sensor that detects a pressure applied to the vehicle 100. In this case, a signal indicating a pressure detected by the pressure sensor and equal to or greater than a threshold is the signal indicating the collision between the vehicle 100 and the object. The collision sensor 400 is, for example, an acceleration sensor that detects an acceleration applied to the vehicle 100. In this case, a signal indicating an acceleration detected by the acceleration sensor and equal to or greater than a threshold is the signal indicating the collision between the vehicle 100 and the object.

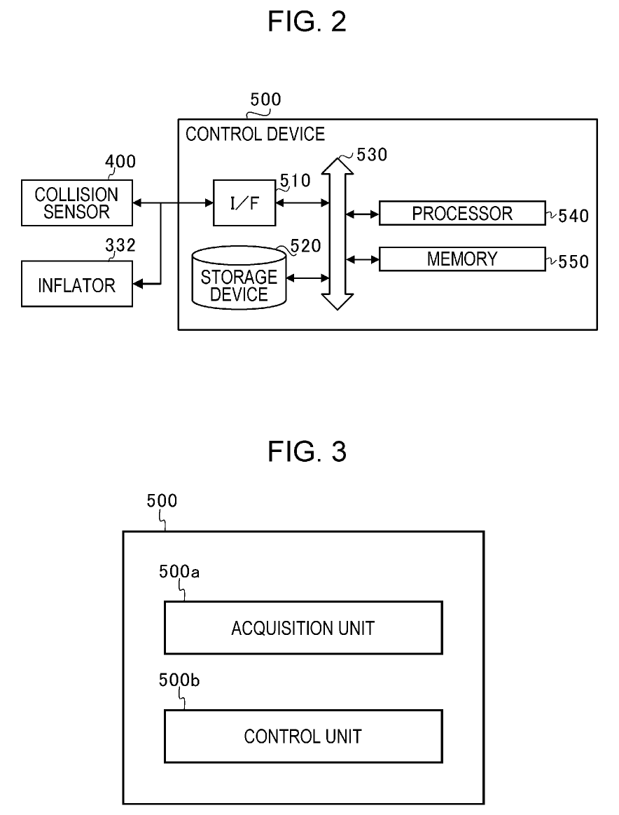

FIG. 2 is a block diagram illustrating an example of a configuration of the control device 500 according to the present embodiment. The control device 500 controls the shoulder retractor 330. As illustrated in FIG. 2, the control device 500 includes an I/F 510, a storage device 520, a system bus 530, one or more processors 540, and one or more memories 550. The I/F 510 is an interface for communication with the collision sensor 400 and the inflator 332.

The storage device 520 is constituted by a RAM, a flash memory, an HDD, or the like, and holds various types of information necessary for processing of the processor 540 described below. The system bus 530 is a transmission path that electrically couples the I/F 510, the storage device 520, the processor 540, and the memory 550 and transmits data therebetween.

The processor 540 includes, for example, a central processing unit (CPU). The memory 550 includes, for example, a read only memory (ROM) and a random access memory (RAM). The ROM is a storage element that stores programs, operation parameters, and the like to be used by the CPU. The RAM is a storage element that temporarily stores data such as variables and parameters to be used for processing executed by the CPU.

FIG. 3 is a block diagram illustrating an example of a functional configuration of the control device 500 according to the present embodiment. For example, as illustrated in FIG. 3, the control device 500 includes an acquisition unit 500a and a control unit 500b.

The processor 540 cooperates with a program included in the memory 550 and executes the program included in the memory 550, thereby implementing various processes including processes described below to be executed by the acquisition unit 500a and the control unit 500b.

The acquisition unit 500a acquires a signal indicating a collision between the vehicle 100 and an object from the collision sensor 400. The control unit 500b controls the inflator 332 based on the signal acquired by the acquisition unit 500a. Specifically, when the signal indicating the collision between the vehicle 100 and the object is acquired from the collision sensor 400, the control unit 500b controls the inflator 332 to operate to generate gas.

In the event of a collision of the vehicle 100 traveling in the forward movement direction, an inertial force acts on the occupant 600 sitting on the seat 200 to move the occupant 600 in the forward movement direction of the vehicle 100. At this time, the pressure applied to the chest of the occupant 600 from the seat belt 310 increases as the position of the ilium of the occupant 600 wearing the seat belt 310 is farther from the turning point of the seat belt 310 at the tongue 350. This is because, as the position of the ilium of the occupant 600 is farther from the turning point, part of the seat belt 310 is more likely to ride on the ilium of the occupant 600 when the occupant 600 leans forward due to the inertial force. The distance from the chest of the occupant 600 to the turning point through the ilium is longer than the shortest distance from the chest of the occupant 600 to the turning point. Therefore, when part of the seat belt 310 rides on the ilium of the occupant 600, the chest of the occupant 600 is tightened by the seat belt 310 as compared with the case where the part of the seat belt 310 does not ride on the ilium. As a result, the pressure applied to the chest of the occupant 600 from the seat belt 310 increases.

In view of this, the seat belt device 300 according to the present embodiment includes an adapter 700 to reduce the pressure applied to the chest of the occupant 600. The adapter 700 is made of a flexible material having a larger friction coefficient than the material of the seat belt 310. The adapter 700 is made of, for example, rubber or silicon. As illustrated in FIG. 1, the adapter 700 is attached to the body 352 of the tongue 350.

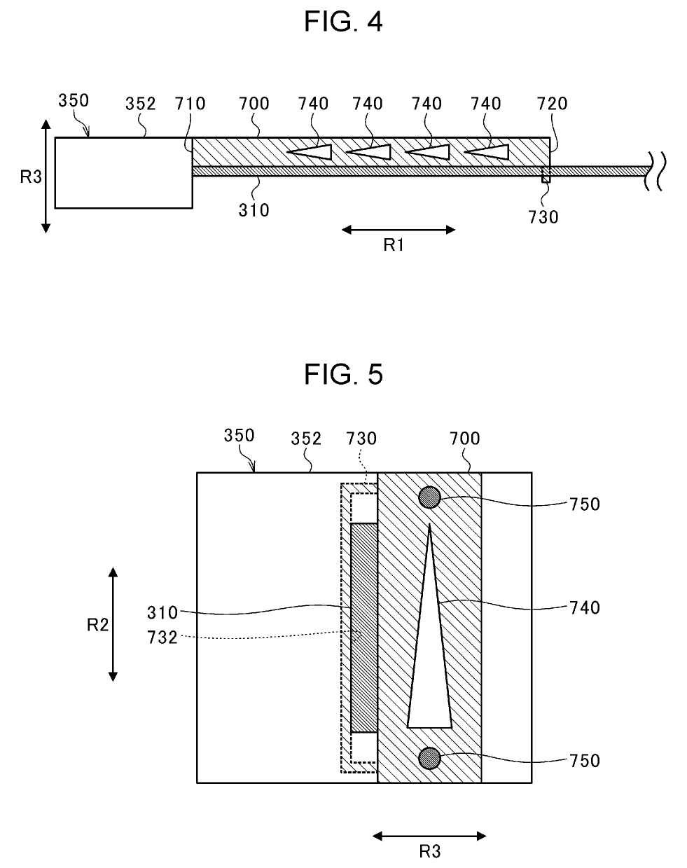

FIG. 4 is a sectional view of the adapter 700 according to the present embodiment as viewed in a width direction. FIG. 5 is a sectional view of the adapter 700 according to the present embodiment as viewed in a longitudinal direction. In FIG. 5, an engagement portion 730 described later is indicated by broken lines for easy understanding. As illustrated in FIG. 4 and FIG. 5, the adapter 700 has, for example, a rectangular parallelepiped shape.

In FIGS. 4 and FIG. 5, the longitudinal direction of the adapter 700 having the rectangular parallelepiped shape is denoted by R1, the width direction of the adapter 700 is denoted by R2, and the thickness direction of the adapter 700 is denoted by R3. The longitudinal direction R1 of the adapter 700 is the same direction as a longitudinal direction R1 of the seat belt 310. The width direction R2 of the adapter 700 is the same direction as a width direction R2 of the seat belt 310. The thickness direction R3 of the adapter 700 is the same direction as a thickness direction R3 of the seat belt 310.

The longitudinal direction R1 of the adapter 700 is a direction orthogonal to the width direction R2 and the thickness direction R3 of the adapter 700. The width direction R2 of the adapter 700 is a direction orthogonal to the longitudinal direction R1 and the thickness direction R3 of the adapter 700. The thickness direction R3 of the adapter 700 is a direction orthogonal to the longitudinal direction R1 and the width direction R2 of the adapter 700.

The adapter 700 extends along the longitudinal direction R1 of the seat belt 310. The adapter 700 has one end 710 and the other end 720 in the longitudinal direction R1. The one end 710 of the adapter 700 is coupled to the body 352 of the tongue 350. The other end 720 of the adapter 700 is provided with the engagement portion 730. As illustrated in FIG. 5, the engagement portion 730 has a C-shape and has a through hole 732. The seat belt 310 is inserted through the through hole 732. The size of the through hole 732 in the width direction R2 is larger than the size of the seat belt 310 in the width direction R2.

The engagement portion 730 is slidable in the longitudinal direction R1 relative to the seat belt 310. In this way, the one end 710 of the adapter 700 is coupled to the body 352 of the tongue 350, and the other end 720 of the adapter 700 is slidable relative to the seat belt 310. Therefore, the adapter 700 is slidable together with the tongue 350 along the longitudinal direction R1 of the seat belt 310.

A plurality of cavities 740 and cores 750 are provided inside the adapter 700. The plurality of cavities 740 is disposed away from each other in the longitudinal direction R1. In the example illustrated in FIG. 4, the plurality of cavities 740 is arranged at regular intervals along the longitudinal direction R1. However, the plurality of cavities 740 may be arranged at irregular intervals along the longitudinal direction R1. The number of the cavities 740 is four in the example illustrated in FIG. 4. However, the number of the cavities 740 is not limited to four as long as it is two or more. The number of the cavities 740 need not be plural but may be single. That is, at least one cavity 740 may be provided inside the adapter 700.

As illustrated in FIG. 4, the size of the cavity 740 in the thickness direction R3 of the adapter 700 is larger on a second direction side away from the tongue 350 than on a first direction side close to the tongue 350. The first direction side is the one end 710 side of the adapter 700, and the second direction side is the other end 720 side of the adapter 700. The size of the cavity 740 in the thickness direction R3 of the adapter 700 increases with increasing distance from the tongue 350 in the longitudinal direction R1.

In a cross section including the longitudinal direction R1 and orthogonal to the width direction R2, the shape of the cavity 740 is, for example, an isosceles triangular shape illustrated in FIG. 4. In other words, the cavity 740 has a wedge shape in the cross section including the longitudinal direction R1 and orthogonal to the width direction R2. However, the shape of the cavity 740 in the cross section including the longitudinal direction R1 and orthogonal to the width direction R2 is not limited thereto, and may be another shape such as a right-angled triangle shape, an equilateral triangle shape, a trapezoidal shape, a fan shape, or a polygonal shape. In any case, it is sufficient that the size of the cavity 740 in the thickness direction R3 of the adapter 700 increases with increasing distance from the tongue 350 in the longitudinal direction R1.

As illustrated in FIG. 5, the size of the cavity 740 in the thickness direction R3 of the adapter 700 increases from one side to the other side in the width direction R2 of the adapter 700. The one side in the width direction R2 of the adapter 700 is an upper side of the adapter 700 when the tongue 350 is attached to the buckle 360. The other side in the width direction R2 of the adapter 700 is a lower side of the adapter 700 when the tongue 350 is attached to the buckle 360. In the state in which the tongue 350 is attached to the buckle 360, the upper side in FIG. 5 is the upper side in the vertical direction, and the lower side in FIG. 5 is the lower side in the vertical direction. In a cross section including the width direction R2 and orthogonal to the longitudinal direction R1, the shape of the cavity 740 is, for example, an isosceles triangular shape illustrated in FIG. 5. In other words, the cavity 740 has a wedge shape in the cross section including the width direction R2 and orthogonal to the longitudinal direction R1. However, the shape of the cavity 740 in the cross section including the width direction R2 and orthogonal to the longitudinal direction R1 is not limited thereto, and may be another shape such as a right-angled triangle shape, an equilateral triangle shape, a trapezoidal shape, a fan shape, or a polygonal shape. In any case, it is sufficient that the size of the cavity 740 in the thickness direction R3 of the adapter 700 increases from the one side to the other side in the width direction R2 of the adapter 700.

The core 750 is made of a high-strength and flexible material such as Kevlar. As illustrated in FIG. 5, a pair of cores 750 is provided on the upper side and the lower side of the cavity 740 in the width direction R2. The pair of cores 750 is not limited thereto as long as they are provided at positions different from that of the cavity 740. For example, the pair of cores 750 may be provided on the left side and the right side of the cavity 740 in the thickness direction R3. The number of the cores 750 may be three or more. The number of the cores 750 need not be plural but may be single.

The core 750 extends along the longitudinal direction R1 from the one end 710 to the other end 720 of the adapter 700. The shape of the core 750 in the cross section including the width direction R2 and orthogonal to the longitudinal direction R1 is, for example, a circular shape. However, the shape of the core 750 in the cross section including the width direction R2 and orthogonal to the longitudinal direction R1 is not limited thereto, and may be another shape such as a triangular shape, a rectangular shape, a polygonal shape, or an elliptical shape.

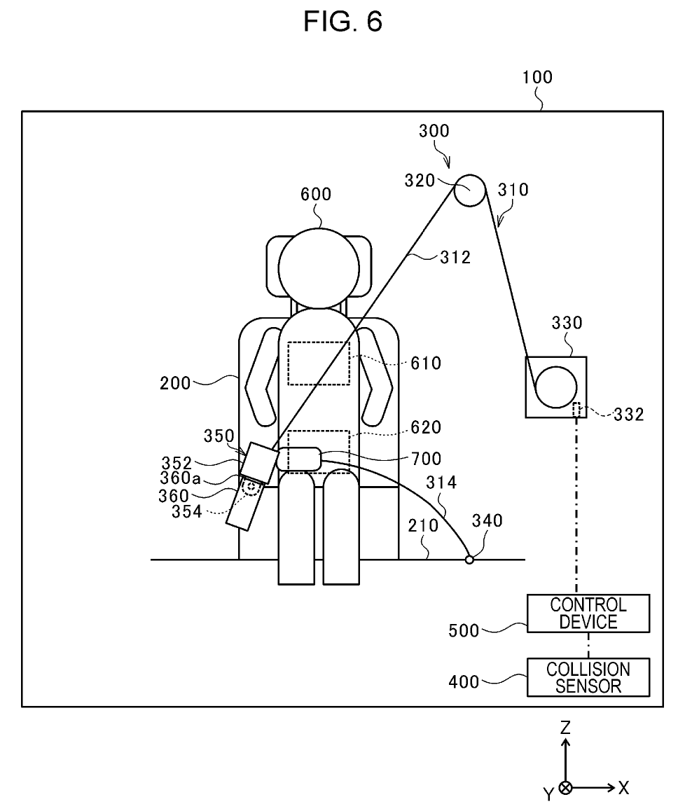

FIG. 6 is a schematic diagram illustrating a seat belt wearing state of the seat belt device 300 according to the present embodiment at the time of non-collision. The term "non-collision" means a period in which a collision of the vehicle 100 is not detected by the collision sensor 400.

As illustrated in FIG. 6, the tongue 350 is attached to the buckle 360 to achieve the seat belt wearing state in which the occupant 600 wears the seat belt 310. In the seat belt wearing state, the seat belt 310 includes a shoulder belt portion 312 and a lap belt portion 314. The shoulder belt portion 312 is a portion of the seat belt 310 from the shoulder retractor 330 to the tongue 350. The lap belt portion 314 is a portion of the seat belt 310 from the tongue 350 to the lap anchor 340.

The shoulder belt portion 312 is a portion that extends obliquely over the shoulder and a chest 610 of the occupant 600 and mainly restrains the shoulder and the chest 610 of the occupant 600. The lap belt portion 314 is a portion that extends over a waist 620 of the occupant 600 in a vehicle width direction and mainly restrains the waist 620 of the occupant 600.

In the present embodiment, the shoulder belt portion 312 and the lap belt portion 314 constitute an integrally continuous single belt. However, the shoulder belt portion 312 and the lap belt portion 314 are not limited thereto, and may be separate members.

As illustrated in FIG. 6, when the tongue 350 is attached to the buckle 360, the adapter 700 attached to the tongue 350 is positioned to face the waist 620 of the occupant 600.

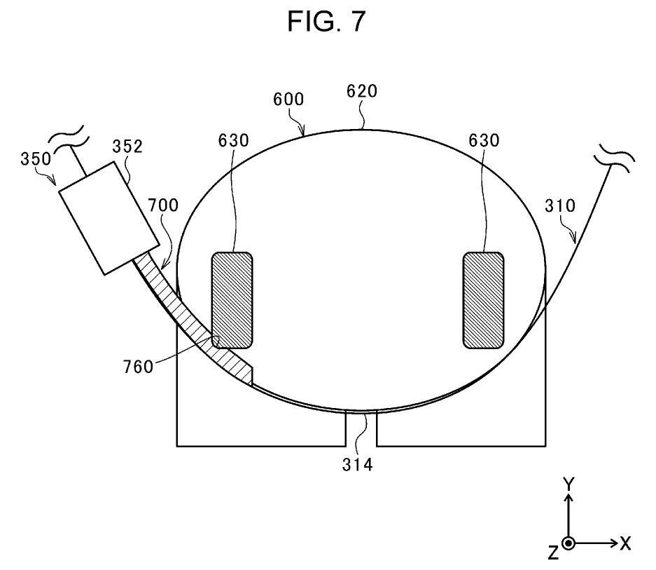

FIG. 7 is a schematic diagram illustrating a positional relationship between the adapter 700 according to the present embodiment and the waist 620 of the occupant 600. As illustrated in FIG. 7, the waist 620 of the occupant 600 includes ilia 630. The ilia 630 are large bones that occupy the upper portions of the left and right hip bones that constitute the human pelvis.

In the seat belt wearing state, the adapter 700 is disposed to extend from the tongue 350 along the inner surface of the seat belt 310. The inner surface of the seat belt 310 is a surface of the seat belt 310 on the occupant 600 side. As illustrated in FIG. 7, the adapter 700 is disposed between the lap belt portion 314 of the seat belt 310 and the waist 620 of the occupant 600. More specifically, in the seat belt wearing state, the adapter 700 is disposed between the lap belt portion 314 of the seat belt 310 and the ilium 630 of the occupant 600. Thus, in the seat belt wearing state, the adapter 700 is sandwiched between the lap belt portion 314 and the ilium 630.

In the seat belt wearing state, the adapter 700 is pushed toward the ilium 630 of the occupant 600 by the tension of the seat belt 310. At this time, as illustrated in FIG. 7, part of the adapter 700 is crushed and deformed by the lap belt portion 314 and the ilium 630, and a recessed portion 760 is formed in the part of the adapter 700.

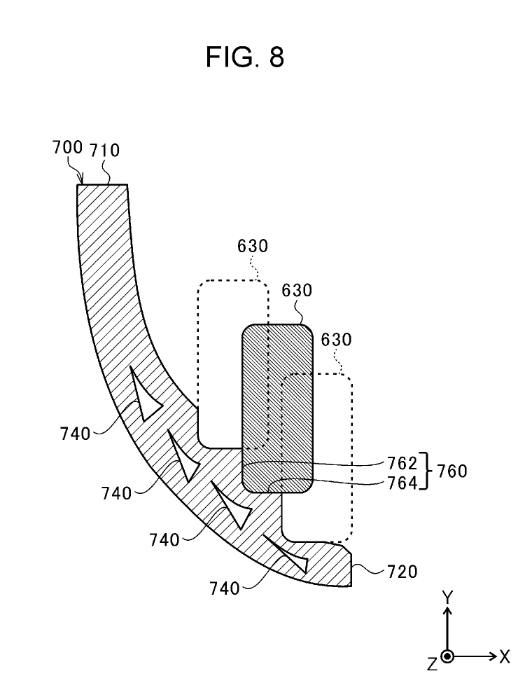

FIG. 8 is a schematic diagram illustrating an engagement state between the adapter 700 according to the present embodiment and the ilium 630. As illustrated in FIG. 8, the cavity 740 is formed inside the adapter 700. When the adapter 700 is crushed between the lap belt portion 314 and the ilium 630, a portion around the cavity 740 of the adapter 700 is easily deformed. Since the cavity 740 is formed inside the adapter 700, it is possible to increase the amount of deformation of the portion around the cavity 740 of the adapter 700. That is, it is possible to increase the amount of recess of the recessed portion 760 formed in the adapter 700 when the adapter 700 is crushed between the lap belt portion 314 and the ilium 630.

A first contact surface 762 that is in contact with the ilium 630 is formed on the -X direction side of the recessed portion 760. A second contact surface 764 that is in contact with the ilium 630 is formed on the -Y direction side of the recessed portion 760. Since the size of the cavity 740 in the thickness direction R3 is larger on the second direction side away from the tongue 350 than on the first direction side close to the tongue 350, the length of the first contact surface 762 in the Y direction is larger than the length of the second contact surface 764 in the X direction. Thus, the contact area between the first contact surface 762 and the ilium 630 can be increased.

As the contact area between the first contact surface 762 and the ilium 630 increases, it becomes easier to regulate the movement of the ilium 630 in the -Y direction. That is, the amount of movement of the ilium 630 in the -Y direction can be reduced by increasing the contact area between the first contact surface 762 and the ilium 630. In other words, the restraining force for the occupant 600 can be increased by increasing the contact area between the first contact surface 762 and the ilium 630.

The cores 750 are provided inside the adapter 700. When the occupant 600 tries to move in the -Y direction in a state in which the ilium 630 is caught by the recessed portion 760 of the adapter 700, the adapter 700 is pulled in the -Y direction. At this time, the load applied to the recessed portion 760 is transmitted to the body 352 of the tongue 350 via the cores 750 of the adapter 700. The tongue 350 is attached to the buckle 360, and the buckle 360 is fixed to the seat 200 or the vehicle body panel 210. Therefore, the load transmitted to the tongue 350 is transmitted to the seat 200 or the vehicle body panel 210 via the buckle 360. Accordingly, when the occupant 600 moves in the -Y direction due to an inertial force in the event of the collision of the vehicle 100, the cores 750 of the adapter 700 transmit the load applied to the recessed portion 760 from the ilium 630 to the seat 200 or the vehicle body panel 210. Thus, the restraining force can be applied to the occupant 600. As a result, the occupant 600 can be restrained by the adapter 700, and the amount of movement of the occupant 600 in the -Y direction can be reduced.

In FIG. 8, the position of the ilium 630 of the occupant 600 may vary depending on the physique of the occupant 600, like the ilia 630 indicated by the broken lines. In the present embodiment, the plurality of cavities 740 is formed in the adapter 700 along the longitudinal direction R1 of the adapter 700. Therefore, even when the position of the ilium 630 varies depending on the physique, the cavity 740 can be disposed at a position corresponding to the position of the ilium 630, and an appropriate restraining force can be applied to the occupant 600 regardless of the physique of the occupant 600.

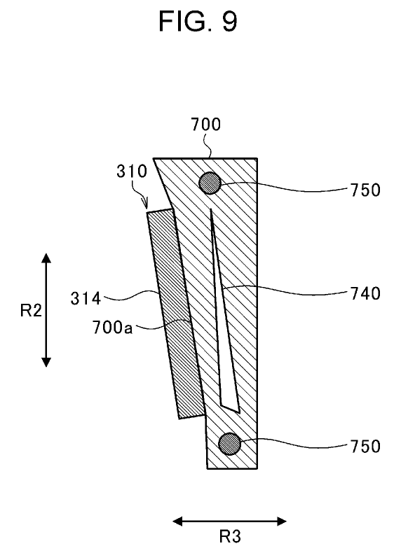

FIG. 9 is a schematic diagram illustrating an engagement state between the adapter 700 according to the present embodiment and the lap belt portion 314. As described with reference to FIG. 5, the size of the cavity 740 in the thickness direction R3 is larger on the lower side than on the upper side. Therefore, when the adapter 700 is crushed and deformed by the tension of the seat belt 310 in the seat belt wearing state, as illustrated in FIG. 9, the amount of deformation on the lower side in the width direction R2 of the adapter 700 is larger than the amount of deformation on the upper side.

Thus, the thickness of the adapter 700 in the thickness direction R3 is larger on the upper side than on the lower side. Since the thickness of the adapter 700 is larger on the upper side than on the lower side, an inclined surface 700a is formed on the side surface of the adapter 700 that is in contact with the lap belt portion 314. The inclined surface 700a is a surface whose lower side is inclined toward the waist 620 of the occupant 600 relative to a vertical plane including the longitudinal direction R1 of the adapter 700. At this time, the width direction R2 of the lap belt portion 314 is inclined along the inclination direction of the inclined surface 700a.

Since the thickness of the adapter 700 is larger on the upper side as illustrated in FIG. 9, part of the adapter 700 is positioned on the upper side of the lap belt portion 314. Thus, the upward movement of the lap belt portion 314 can be regulated. That is, the upward displacement of the lap belt portion 314 relative to the adapter 700 can be suppressed.

As described above, the seat belt device 300 of the present embodiment includes the adapter 700 that is attached to the tongue 350 and is made of a flexible material having a larger friction coefficient than the material of the seat belt 310. Since the adapter 700 is made of the material having a larger friction coefficient than the material of the seat belt 310, the restraining force for the occupant 600 in the seat belt wearing state can be increased. The adapter 700 is disposed to extend from the tongue 350 along the inner surface of the seat belt 310. In a state in which the tongue 350 is attached to the buckle 360, the adapter 700 is disposed between the seat belt 310 and the ilium 630 of the occupant 600. Thus, a restraining force greater than that of the seat belt 310 alone can be applied to the occupant 600. Therefore, it is possible to suppress the movement of the occupant 600 in the forward movement direction due to the inertial force in the event of a collision of the vehicle 100. As a result, it is possible to reduce the pressure applied to the chest 610 of the occupant 600 from the seat belt 310 in the event of the collision.

The adapter 700 has at least one cavity 740. The size of the cavity 740 in the thickness direction R3 of the adapter 700 increases with increasing distance from the tongue 350 in the longitudinal direction R1. As a result, the contact area between the ilium 630 and the first contact surface 762 of the recessed portion 760 formed in the adapter 700 can be increased, and the restraining force for the occupant 600 can be increased.

The size of the cavity 740 in the thickness direction R3 of the adapter 700 increases from the one side to the other side in the width direction R2 of the adapter 700. The one side in the width direction R2 of the adapter 700 is the upper side of the adapter 700 when the tongue 350 is attached to the buckle 360. The other side in the width direction R2 of the adapter 700 is the lower side of the adapter 700 when the tongue 350 is attached to the buckle 360. Thus, the thickness of the adapter 700 on the upper side can be increased, and the upward movement of the lap belt portion 314 can be regulated.

The adapter 700 includes the core 750 extending along the longitudinal direction R1. Accordingly, when the occupant 600 moves in the -Y direction due to an inertial force in the event of a collision of the vehicle 100, the core 750 of the adapter 700 can transmit the load applied to the recessed portion 760 from the ilium 630 to the seat 200 or the vehicle body panel 210. As a result, the restraining force can be applied to the occupant 600 in the event of the collision of the vehicle 100.

The adapter 700 has the plurality of cavities 740. The plurality of cavities 740 is disposed away from each other in the longitudinal direction R1. Therefore, even when the position of the ilium 630 varies depending on the physique, the cavity 740 can be disposed at a position corresponding to the position of the ilium 630, and an appropriate restraining force can be applied to the occupant 600 regardless of the physique of the occupant 600.

Although the exemplary embodiment of the disclosure is described above with reference to the accompanying drawings, the embodiment of the disclosure is not limited to such an embodiment. It will be apparent to persons having ordinary skill in the art that various modifications and variations can be made within the scope of the appended claims. It is understood that these modifications and variations are pertinent to the technical scope of the disclosure.

The above embodiment illustrates the example in which the cavity 740 is provided inside the adapter 700. However, the cavity 740 is not an essential component, and the cavity 740 need not be provided inside the adapter 700.

The above embodiment illustrates the example in which the core 750 is provided inside the adapter 700. However, the core 750 is not an essential component, and the core 750 need not be provided inside the adapter 700.

1. A seat belt device comprising:
a seat belt;
a tongue attached to the seat belt such that the tongue is slidable in a longitudinal direction;
a buckle to and from which the tongue is configured to be attached and detached; and
an adapter that is attached to the tongue and is made of a flexible material having a larger friction coefficient than a material of the seat belt, wherein
the adapter is disposed to extend from the tongue along an inner surface of the seat belt, and
the adapter is configured such that, in a state in which the tongue is attached to the buckle, the adapter is disposed between the seat belt and an ilium of an occupant.

2. The seat belt device according to claim 1, wherein
the adapter has at least one cavity, and
a size of the cavity increases with increasing distance from the tongue in the longitudinal direction.

3. The seat belt device according to claim 1, wherein
the adapter has at least one cavity,
a size of the cavity increases from one side to another side in a width direction of the adapter,
the one side in the width direction of the adapter is an upper side of the adapter when the tongue is attached to the buckle, and
the another side in the width direction of the adapter is a lower side of the adapter when the tongue is attached to the buckle.

4. The seat belt device according to claim 1, wherein the adapter comprises a core extending along the longitudinal direction.

5. The seat belt device according to claim 2, wherein
the adapter has a plurality of instances of the cavity, and
the instances of the cavities are disposed away from each other in the longitudinal direction.

6. The seat belt device according to claim 3, wherein
the adapter has a plurality of instances of the cavity, and
the instances of the cavities are disposed away from each other in the longitudinal direction.
